(19) United States
(12) Patent Application Publication
(10) Pub. No.: US 2003/0172160 A9
(43) Pub. Date: Sep. 11, 2003

(54) Method and apparatus for coordinating end-to-end quality of service requirements for media flows in a multimedia session

(76) Inventors: Ina B. Widegren, Stockholm (SE); Johnson Oyama, Solna (SE); Thian J. Tan, Victoria (AU); Brian C. Williams, Victoria (AU)

Correspondence Address: NIXON & VANDERHYE P.C., 8th Floor, 1100 North Glebe Road, Arlington, VA, 22201, US

(21) Appl. No.: 10/038,770

(22) Filed: Jan. 8, 2002

Related U.S. Application Data
(60) Provisional application No. 60/275,354, filed on Mar. 13, 2001.
(60) Provisional application No. 60/273,678, filed on Mar. 6, 2001.
(60) Provisional application No. 60/269,573, filed on Feb. 16, 2001.
(60) Provisional application No. 60/269,789, filed on Feb. 16, 2001.
(60) Provisional application No. 60/269,572, filed on Feb. 16, 2001.
(60) Provisional application No. 60/260,766, filed on Jan. 10, 2001.
(60) Provisional application No. 60/324,523, filed on Sep. 26, 2001.

(51) Int. Cl. G06F 15/16; G06F 15/173

(52) U.S. Cl. 709/226; 709/249

(57) ABSTRACT

The present invention provides a method to assure end-to-end quality of service for a multimedia session including plural media data streams. The multimedia session is between a first user terminal associated with a first local access network and a second user terminal associated with a second local access network. The first and second local networks are coupled to an IP backbone network. During session setup, the user terminals each request confirmation from the other that its local access network can provide the quality of service requested for the session. The first user terminal determines whether there are sufficient resources in the first local access network to support a quality of service in its local access network to support a quality of service requested for each of the media data streams. Once this is determined, the first user terminal sends a message to the second user terminal confirming that QoS assurance. Similarly, the second user terminal determines that there are sufficient resources in the second local access network to support the quality of service requested for each media data stream. A message is sent to the first user terminal confirming that quality of service determination. The IP network supports the requested quality of service for each media data stream in the session without the need for any formal resource reservation signaling using, for example, the differentiated services QoS provisioning mechanism, network dimensioning, and traffic engineering. Thus, the requested quality of service for each media data stream in the session can be assured without having to use more complex, costly, and less flexible resource reservation protocols.

### CROSS-REFERENCE TO RELATED APPLICATIONS

This application is related to commonly-assigned U.S. patent application Ser. No. 09/768,956, entitled “RSVP Handling in 3G Networks,” filed on Jan. 24, 2001; U.S. patent application Ser. No. 09/861,817, entitled “Application Influenced Policy,” filed on May 21, 2001; U.S. patent application Ser. No. 09/985,573, entitled “Media Binding to Coordinating Quality of Service Requirements for Media Flows in a Multimedia Session with IP Bearer Resources,” filed Nov. 5, 2001; and U.S. patent application Ser. No. 09/985,633, entitled “Method and Apparatus for Coordinating Charges for Services Provided in a Multimedia Session,” filed Nov. 5, 2001; and U.S. patent application Ser. No. 09/985,631, entitled “Method and Apparatus for Coordinating Quality of Service Requirements for Media Flows in a Multimedia System With IP Bearer Resources,” filed Nov. 5, 2001; the disclosures of which are incorporated herein by reference.

### REFERENCE TO PRIORITY APPLICATIONS

This application claims priority from and incorporates by reference the following commonly-assigned provisional patent applications: No. 60/275,354 entitled “Enhancement of Authorization Token for RSVP Interworking,” filed Mar. 13, 2001; No. 60/273,678 entitled “SDP Support for QoS Based SIP Sessions,” filed Mar. 6, 2001; No. 60/269,573 entitled “QoS Characteristics for a UMTS Bearer Appropriate for IP Signaling,” filed Feb. 16, 2001; No. 60/269,789 entitled “Architecture for Packet Data Protocol Context Suitable for Signaling,” filed Feb. 16, 2001; No. 60/269,572 entitled “Binding a Signaling Bearer for Use With an IP Multimedia Subsystem,” filed Feb. 16, 2001; No. 60/260,766 entitled “QoS Pre-Condition Met,” filed Jan. 10, 2001; and No. 60/324,523, entitled “Use of GPRS APN in IMS/Ipv6 Context,” filed on Sep. 26, 2001.

### FIELD OF THE INVENTION

The present invention generally relates to Internet Protocol (IP) networks, and more specifically, to assuring Quality of Service (QoS) multimedia sessions across an IP network.

### BACKGROUND

IP networks were originally designed to carry “best effort” traffic where the network makes a “best attempt” to deliver a user packet, but does not guarantee that a user packet will arrive at the destination. Because of the market success of IP networks, there is a clear requirement for mechanisms that allow IP networks to support various types of applications. Some of these applications have Quality of Service (QoS) requirements other than “best effort” service. Examples of such applications include various real time applications (IP Telephony, video conferencing), streaming services (audio or video), or high quality data services (browsing with bounded download delays). Recognizing these QoS requirements, the Internet Engineering Task Force (IETF), which is the main standards body for IP networking, standardized a set of protocols and mechanisms that enable IP network operators to build QoS-enabled IP networks.

FIG. 1 depicts a simplified high-level model of an IP network accessed by end users via associated access networks which may be useful in explaining QoS provisioning. As can be appreciated, the model includes two users, but could easily be expanded to include more users without changing the basic functionality of the network. In FIG. 1, User-A 101 may communicate with User-B 102 or with an application server 103. For example, in the case of an IP telephony session, User-A 101 may communicate with User-B 102. Similarly, in the case of streaming services, User-A 101 may communicate with the application server 103, which may be configured as a video server. In either case, User-A 101 accesses an IP backbone network 104 through a local access network 105, such as PSTN (dial-in access), Global System for Mobile Communications (GSM), or Universal Mobile Telecommunications System (UMTS) network. User-B 102 is similarly connected to the IP network 104 through a local access network 106. Of particular interest to this invention is the specific case where at least one of the access networks is a UMTS or GSM/GPRS network. However, User-A and User-B need not use the same type of access network. The IP network 104 may consist of a number of IP routers and interconnecting links that together provide connectivity between the IP network's ingress and egress points and thereby make two party communication possible. As far as the users are concerned, the QoS depends on both of the access networks 105, 106 and on the IP backbone network 104.

When users access IP-based services, they typically use a device that runs an application program that provides the interface for the user to access the particular service. For instance, in FIG. 1, User-A may use a laptop running a conferencing application program to attend an IP network based meeting, where participants of the meeting collaborate using various programs. Such programs are well known in the art.

Various user applications may access network services through an application programming interface (API). An API provides application programmers with a uniform interface to access underlying system resources. For instance, an API may be used to configure a network resource manager to require that a particular IP packet originating from a given application receive a certain treatment from the network, such as a particular QoS. For example, if the IP network is a Differentiated Services IP network, then an application program may request that all of its IP packets receive the “Expedited Forwarding” treatment.

The User (and the API in the user's equipment) may not be aware of the different technologies that various access networks and IP backbone networks employ in order to provide QoS end-to-end, i.e., from User-A all the way to remote User-B. For instance, the application program may use an RSVP/IntServ based API, and the end-to-end embodiment in which he is involved may include a UMTS access network and a non-RSVP enabled IP network. In such cases, some “interworking” mechanisms between such different technologies and protocols are needed to make sure that the QoS is provided end-to-end.

Integrated Services (IntServ) provides a set of well-defined services which enables an application to choose among multiple, controlled levels of delivery service for their data packets. To support this capability, two things are required. First, individual network elements, such as subnets and IP routers, along the path followed by an application's data packets must support mechanisms to control the quality of service delivered to those packets. Second, a way to communicate the application's requirements to network elements along the path and to convey QoS management information between network elements and the application must be provided.

IntServ defines a number of services such as Controlled-Load (defined in IETF RFC 2211) and Guaranteed (defined in IETF RFC 2212). The service definition defines the required characteristics of the network equipment in order to deliver the service. The individual network elements (subnets and IP routers) that support the service must comply with the definitions defined for the service.

The service definition also defines the information that must be provided across the network in order to establish the service. This function may be provided in a number of ways, but it is frequently implemented by the resource reservation setup protocol RSVP (defined in IETF RFC 2205). RSVP (Resource reSerVation Protocol) is an IP-level resource reservation setup protocol designed for an IntServ-enabled Internet (defined in IETF RFC 1633, 2205, and 2210). The RSVP protocol is used by a host (e.g., User A's computer) to request specific service from the network for particular application data streams or flows. RSVP is also used by routers to deliver quality-of-service requests to all nodes along the path(s) of the flows and to establish and maintain the state(s) to provide the requested service. RSVP requests generally result in resources being reserved in each node along the data path.

FIG. 2 shows an End-to-End Integrated Service between the hosts. The service is provided using routers and hosts that support the service definition defined for the required service and through signaling of the relevant information between the nodes. Since RSVP is a protocol that is primarily designed to be end-to-end, extra functionality is required in a situation where the RSVP sender would like to use it for resource reservation only in some portion of the end-to-end path. This situation may arise if RSVP is used in an access network and over-provisioning is used in the backbone network. In such situations, an RSVP (Receiver) Proxy is useful.

Unfortunately, RSVP has a number of drawbacks. First, RSVP adds overhead because of the extra layer of signaling, a particular problem in a UMTS or other type of access network that includes a radio interface where radio bandwidth is limited. Second, this added message/signaling exchange increases the overall session setup time. Third, RSVP requires RSVP-enabled routers to examine IP headers in some detail, and it requires those routers to maintain states for all existing reservations. Given there might be millions of concurrent reservations, this situation translates into significant overhead and demonstrates the difficulty of “scaling” RSVP to large systems. Fourth, in the context of UMTS access networks and UMTS terminals, UMTS already establishes a quality of service at the radio access bearer level. RSVP therefore introduces a second level of quality of service protocols that must be coordinated with the UMTS quality of service protocols.

In many cases, a satisfactory quality of service may be provided to numerous applications without the complexity and overhead of RSVP. Differentiated Services (DiffServ) is one means for achieving this goal. Differentiated Services enhancements to the Internet protocol are intended to enable scalable service discrimination in the Internet without the need for per-flow state and signaling at every hop. A variety of services may be built from a small, well-defined set of building blocks which are deployed in network nodes. The services may be either end-to-end or intra-domain; they include both those that can satisfy quantitative performance requirements (e.g., peak bandwidth) and those based on relative performance (e.g., “class” differentiation). Services may be constructed by a combination of setting bits in an IP header field at network boundaries (autonomous system boundaries, internal administrative boundaries, or hosts), using those bits to determine how packets are forwarded by the nodes inside the network, and conditioning the marked packets at network boundaries in accordance with the requirements or rules of each service.

Differentiated Services defines an edge router at the network boundary, and core routers within the network. The edge and core routers have different duties. The edge router must condition the traffic to ensure that it conforms to the service agreement. It also marks the traffic with the appropriate DSCP (Differentiated Services Code Point). It then forwards the packet according to the service behavior defined for that DSCP. The service behavior, called the Per Hop Behavior (PHB) may define the prioritization or weighting of that traffic to give it better service than other traffic. The core nodes examine the DSCP and apply the service behavior appropriate for that service. FIG. 3 shows an end-to-end service. The DS edge routers perform the traffic conditioning, while the DS core routers simply apply the PHB.

To realize a QoS Service with clearly defined characteristics and functionality, a QoS bearer must be set up from the source to the destination of the service. A bearer is a logical connection between two entities through one or more interfaces, networks, gateways, etc., and usually corresponds to a data stream or data flow. A QoS bearer service includes all aspects to enable the provision of a contracted QoS. These aspects are among others the control signaling, user plane transport, and QoS management functionality.

Mobile Radio Access Data Networks, like General Packet Radio Service (GPRS) and Universal Mobile Telecommunication System (UMTS), may form a part of the overall network and will typically be a significant factor in the end-to-end bearer service for customers connected to it. Hence, the bearer service over a GPRS/UMTS network must provide its part of the required end-to-end bearer service.

The GPRS/UMTS network includes a set of network elements between the host, referred to as the Mobile Station (MS), and an external packet switching network the user is connecting to like the Internet. These network elements are shown in FIG. 4. The radio access network (RAN) provides access over the radio interface to/from the mobile station (MS) host. The RAN is coupled to a Serving GPRS Support Node (SGSN) and a Gateway GPRS Support Node (GGSN). The GGSN provides the interworking with external packet-switched networks, e.g., the Internet.

Before a mobile host can send packet data to a remote host, the mobile host must “attach” to the GPRS network to make its presence known and to create a packet data protocol (PDP) context. The PDP context establishes a relationship with a GGSN towards the external network that the mobile host is accessing. The PDP attach procedure is carried out between the mobile host and the SGSN to establish a logical link. As a result, a temporary logical link identity is assigned to the mobile host. A PDP context is established between the mobile host and a GGSN selected based on the name of the external network to be reached. One or more application flows (sometimes called “routing contexts”) may be established over a single PDP context through negotiations with the GGSN. Again, an application flow corresponds to a stream of data packets distinguishable as being associated with a particular host application. An example application flow is an electronic mail message from the mobile host to a fixed terminal. Another example application flow is a link to a particular Internet Service Provider (ISP) to download a graphics file from a website. Both of these application flows are associated with the same mobile host and the same PDP context. User data is transferred transparently between the MS and the external data networks with a method known as encapsulation and tunneling: data packets are equipped with PS-specific protocol information and transferred between the MS and the GGSN.

Quality of Service (QoS) has an extremely important and central role in 3^{rd} generation (3G) UMTS mobile networks. QoS is a means for providing end users with satisfying service. QoS also enables efficient use of the spectrum resources. Because the invention will be described in terms of a UMTS QoS architecture, a brief overview of QoS in UMTS is provided. The 3G UMTS QoS architecture is described, including an explanation of the packet data protocol context (PDP context), a traffic flow template (TFT), and the QoS maintenance procedures for activated UMTS bearers. It is expected that the QoS characteristics associated with a radio communication are the most critical in the end-to-end chain. Within UMTS access networks, the radio network resources are managed on a per PDP context level, which corresponds to one or more user flow/data streams and a certain QoS level.

The QoS framework for 3G networks is specified in the 3G specification (3QPP) TS23.107. The main focus is on the QoS architecture to be used in the UMTS level, where the list of QoS attributes applicable to UMTS Bearer Service and the Radio Access Bearer Service are specified along with appropriate mapping rules. TS23.060 specifies the general mechanisms used by data packet connectivity services in the UMTS level, which includes the General Packet Radio Service (GPRS) in GSM and UMTS.

In a UMTS QoS Architecture, a network service is considered to be end-to-end, from a Terminal Equipment (TE) to another TE. To realize a certain end-to-end QoS, a bearer service with clearly defined characteristics and functionality is set up from the source to the destination of a service. Again, the bearer service includes those aspects needed to enable the provision of a contracted QoS, e.g., control signaling, user plane transport, QoS management and functionality.

A UMTS bearer service layered architecture is depicted in FIG. 5. Each bearer service on a specific layer offers its individual services using services provided by the layers below. Bearers at one layer are broken down into underlying bearers, each one providing a QoS realized independently of the other bearers. Service agreements are made between network components, which are arranged horizontally in FIG. 5. The service agreements may be executed by one or more service layers. For instance, the UMTS bearer service consists of a Radio Access Bearer (RAB) service and a Core Network (CN) bearer service. The RAB service is then divided into a radio bearer service and a Iu bearer service. The Iu interface is the interface between the radio access network and the core network.

The following are examples of the entities shown in FIG. 5. The terminal equipment (TE) may be a laptop and the mobile terminal (MT) may be a cellular radio handset. The UTRAN may be made up of a combination of radio base stations called Node B's and radio network controllers (RNCs). The Core Network (CN) Iu Edge Node may be a serving GPRS support node (SGSN), and the CN Gateway may be a gateway GPRS support node (GGSN).

The QoS management functions in UMTS are used to establish, modify, and maintain a UMTS Bearer Service with a specific QoS, as defined by specific QoS attributes. The QoS management functions of all the UMTS entities ensure provision of the negotiated UMTS bearer service.

The UMTS architecture comprises four management functions in the control plane and four in the user plane. The four control plane management functions are shown in FIG. 6:

Bearer Service (BS) Manager sets up, controls, and terminates the corresponding bearer service. Each BS manager also translates the attributes of its level to attributes of the underlying bearer service during service requests.

Translation function converts between external service signaling and internal service primitives including the translation of the service attributes, and is located in the MT and in the CN Gateway.

Admission/Capability control determines whether the network entity supports the specific requested service, and whether the required resources are available.

Subscription Control determines whether the user has the subscription for the bearer being requested.

The four user plane management functions are:

Classification function resides in the GGSN and in the MT. It assigns user data units (e.g. IP packets) received from the external bearer service from the remote terminal (or the local bearer service) from the local terminal to the appropriate UMTS bearer service according to the QoS requirements of each user data unit. This is where the traffic flow template (TFT) and packet filters are situated, as described below.

Mapping function marks each data unit with the specific QoS indication related to the bearer service to which it has been classified. For example, it adds different service code points to packets before putting them on the Iu or CN bearer.

Resource Manager distributes its resources between all bearer services that are requesting use of these resources. The resource manager attempts to provide the QoS attributes required for each individual bearer service. An example of resource manager is a packet scheduler.

Traffic conditioner is a shaping and policing function which provides conformance of the user data traffic with the QoS attributes of the concerned UMTS bearer service. This resides in the GGSN and in the MT as well as in the UTRAN.

The QoS management functions of the UMTS bearer service in the user plane are shown in FIG. 7. These functions together maintain the data transfer characteristics according to the commitments established by the UMTS bearer service control functions, expressed by the bearer service attributes. The user plane uses the QoS attributes. The relevant attributes are provided to the user plane management functions by the QoS management control functions.

Four different QoS classes standardized in UMTS are shown in FIG. 8. Data transport may be optimized for the corresponding type of application data or for a bearer service of a certain class. The main distinguishing factor between these classes is how delay sensitive the traffic is: Conversational class is meant for traffic which is very delay sensitive (for real-time services) while Background class is the most delay insensitive traffic class (for non-real time services). Bit error/packet loss rate is also a significant difference between the classes.

To characterize a bearer service in detail, a set of bearer service attributes are standardized in UMTS as shown in the tables referenced below. A certain QoS is requested by selecting a set of attribute values that describes the bearer requirement. Parameters differ depending on the type of bearer service requested. FIG. 9 shows which example attributes might be applicable to which example traffic class.

A UE subscription is associated with one or more Packet Data Protocol (PDP) addresses, i.e., IP addresses in the case of IP traffic. Each PDP address is described by one or more PDP contexts stored in the MS, the SGSN, and the GGSN. Default values are also available in the cellular system database, e.g., the HLR, which holds the subscription information. Each PDP context may be associated with a Traffic Flow Template (TFT). A Traffic Flow Template is a packet filter (or set of filters) that associates packets to the correct PDP context thereby ensuring that packets are forwarded with correct QoS characteristics. The relationship between PDP address, PDP context, and TFT is provided in FIG. 10. A PDP context is implemented as a dynamic table of data entries comprising all needed information for transferring PDP PDUs between MS and GGSN, for example addressing information, flow control variables, QoS profile, charging information, etc. The relation between UMTS bearer services and PDP context is a one-to-one mapping, i.e., if two UMTS bearer services are established for one PDP address, two PDP contexts are defined. The PDP context procedures are standardized in TS23.060.

Because there are several data flows in a multimedia session, each data flow is supported by a PDP context in the UMTS network which ensures a certain quality of service for the data flows. Namely, a specific transport channel transporting such a flow will have sufficient resources to support that requested quality of service. For the session initiating user, UE-A, it is important to be assured that there are sufficient resources all the way to the remote user UE-B so that the multimedia session will work properly. Paying users naturally want end-to-end quality of service assurance before the session starts.

Consider the case where the multimedia communication is charged on a traffic volume basis and the cost to the user depends on the number of bits sent or received. The user will want to know in advance whether a session using a video application component will be supported with sufficient QoS so that the video will work properly. If not, the user may well want to disconnect the video component to avoid paying for useless data transport. If both UE-A and UE-B must pay for the traffic volume using their respective local access networks, both users will want to know the QoS status of the of the other side.

End-to-end quality of service assurance is also important in a situation where a terminating application at the UE-B side is designed not to alert the end user unless there are sufficient resources to support the session end-to-end. In other words, the phone will not ring at UE-B unless there are enough resources all the way to UE-A, which is the typical procedure followed in a normal telephone call to a PSTN phone. To determine if the resources of the local access network of UE-A are reserved or assured, UE-A needs to inform UE-B. Similarly, if sufficient resources of UE-B's local access network are also reserved or assured, UE-B needs to inform UE-A.

For traditional PSTN telephony, the above problems are solved relatively simply by signaling between switches and by using a dedicated connection to transport the data. However, when IP-based data communications and applications are used to provide real-time services, like voice-over-IP, end-to-end coordination of available transmission resources to assure a particular quality of service is a more troublesome problem. Unlike PSTN-type dedicated connections, IP networks are “connection-less,” and therefore, control of individual IP flows from both a signaling and traffic management perspective is more complicated than it is for connection-oriented networks.

One approach is to control quality of service end-to-end across all path segments in an IP-based, connection-less communications is to use the RSVP protocol. However, as noted above, there are significant limitations and drawbacks with using the RSVP protocol. The present invention offers a different and less burdensome approach to assure end-to-end QoS for IP communications. Each user's local access network, e.g., a GPRS/UMTS network, is responsible for securing the necessary QoS for a session from the user's equipment through its local access network to the IP backbone network. Each user requests confirmation from the other when the necessary QoS conditions have been met in the respective local access networks. The quality of service demands for a session are provisioned in the IP backbone network using Differentiated Services (DiffServ). In this way, successful (or failed) provisioning of the necessary end-to-end quality of service will be known to both users before the session starts.

Thus, the present invention provides a method to assure end-to-end quality of service for a multimedia session including plural media data streams. The multimedia session is between a first user terminal associated with a first local access network and a second user terminal associated with a second local access network. The first and second local networks are coupled to an IP backbone network. During session setup, the user terminals each request confirmation from the other that its local access network can provide the quality of service requested for the session. The first user terminal determines whether there are sufficient resources in the first local access network to support a quality of service in its local access network to support a quality of service requested for each of the media data streams. Once this is determined, the first user terminal sends a message to the second user terminal confirming that QoS assurance. Similarly, the second user terminal determines that there are sufficient resources in the second local access network to support the quality of service requested for each media data stream. A message is sent to the first user terminal confirming that quality of service determination.

The IP network supports the requested quality of service for each media data stream in the session without the need for any formal resource reservation signaling using, for example, the differentiated services QoS provisioning mechanism. In order to assure sufficient resources in the IP network so that the media streams will be transported according to the requested QoS, the IP network is appropriately dimensioned and traffic engineered. For example, each GGSN may be configured to only use a limited amount of resources (bandwidth) of the IP network. Accordingly, the IP network is dimensioned to carry the sum of the traffic from all GGSNs. If this limit is reached, no more multimedia flows will be admitted, and an admission control function in GGSN will reject new activation requests. If there are enough resources in both of the local access networks, and the two GGSNs are within their bandwidth limits, the requested quality of service for each media data stream in the session can be assured without having to use more complex, costly, and less flexible resource reservation protocols.

If the requested quality of service for any one of the media data streams in the session cannot be satisfactorily provisioned in one of the first and second local access networks, the corresponding user terminal indicates that failure to the other terminal and appropriate action can be taken. One action may be to abort the session. Alternatively, the setup of the session may be attempted with a changed condition, e.g., quality of service for one or more of the media data streams is changed. Still further, UE-A or UE-B may attempt to set up the session without requiring any special QoS assurance for one or several media streams, allowing each side to use whatever QoS level that is provided by the local access network for each media stream, e.g., best effort.

In one non-limiting, example application, the first and second local access networks are GPRS or UMTS networks. The first user terminal is a mobile terminal which uses a packet data context activation procedure to determine if sufficient resources can be provisioned in its local GPRS/UMTS access network to support a quality of service requested for each of the media data streams in the session. If so, the first mobile terminal sends a quality of service confirmation message using session initiation protocol (SIP) signaling to the second mobile terminal. The second mobile also initiates a packet data context activation procedure to determine if sufficient resources can be provisioned in its GPRS/UMTS local access network to support a quality of service requested for each of the media data streams in the session. If so, the second mobile terminal sends a quality of service SIP confirmation message to the first mobile terminal.

### BRIEF DESCRIPTION OF THE DRAWINGS

The foregoing and other objects, features, and advantages of the present invention may be more readily understood with reference to the following description taken in conjunction with the accompanying drawings.

FIG. 1 is a block diagram of a high level IP network;

FIG. 2 is a block diagram depicting an example of a network employing end-to-end integrated services;

FIG. 3 is a block diagram depicting an example of a network employing end-to-end differentiated services;

FIG. 4 is a block diagram depicting a mobile access data network modeled as a DiffServ network;

FIG. 5 is a block diagram of a UMTS quality of service architecture;

FIG. 6 is a block diagram depicting quality of service management for UMTS bearer services in the control plane;

FIG. 7 is a block diagram depicting quality of service management functions for UMTS bearer services in the user plane;

FIG. 8 is a table of UMTS quality of services classes;

FIG. 9 is a table of quality of service attributes;

FIG. 10 is a block diagram of the relationship between PDP address, PDP context, and TFT;

FIG. 11 is a diagram illustrating end-to-end quality of service assurance for a communications session;

FIG. 12 is a flowchart illustrating example procedures for a quality of service assurance for a multimedia session;

FIG. 13 is a diagram illustrating an example of end-to-end quality of service assurance in a GPRS/UMTS-based communications system for conducting a multimedia session;

FIG. 14 is a more detailed, example for assuring end-to-end quality of service for a multimedia session where the local access networks are UMTS or GPRS networks;

FIG. 15 illustrates an IP multimedia quality of service assurance procedure that may be used, for example, in either of the multimedia communications shown in FIGS. 13 and 14;

FIG. 16 is a signaling diagram illustrating signaling for setting up a multimedia session in the systems of FIGS. 13 and 14 including procedures for assuring quality of service assurance from the perspective of the originating mobile network;

FIG. 17 is a signaling diagram illustrating signaling for setting up a multimedia session in the systems of FIGS. 13 and 14 including procedures for assuring quality of service assurance from the perspective of the terminating mobile network;

FIG. 18 is a signaling diagram of PDP context message exchanges; and

FIG. 19 is a simplified block diagram of a mobile terminal UE.

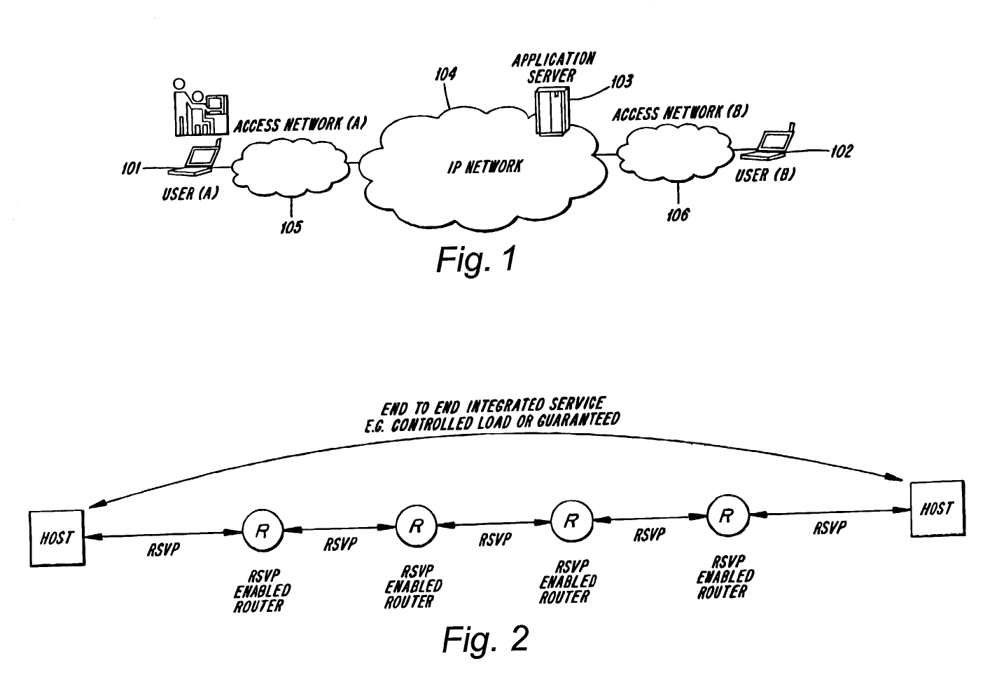

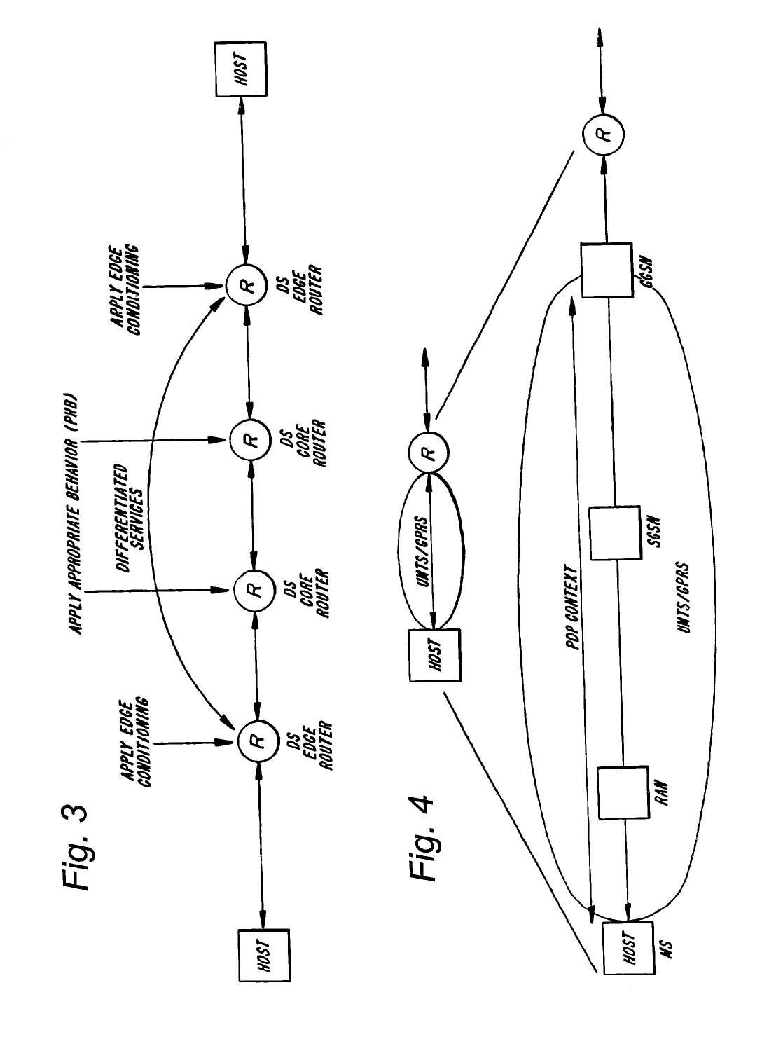

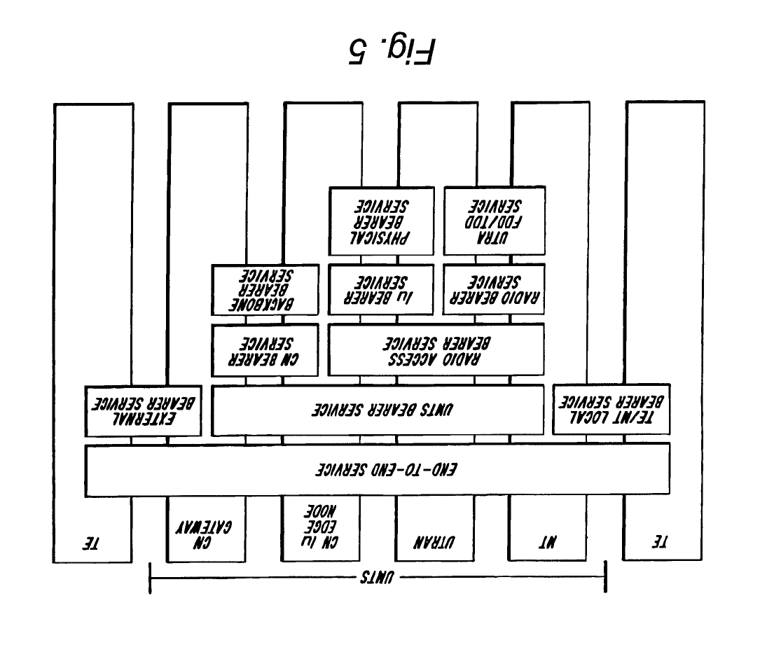

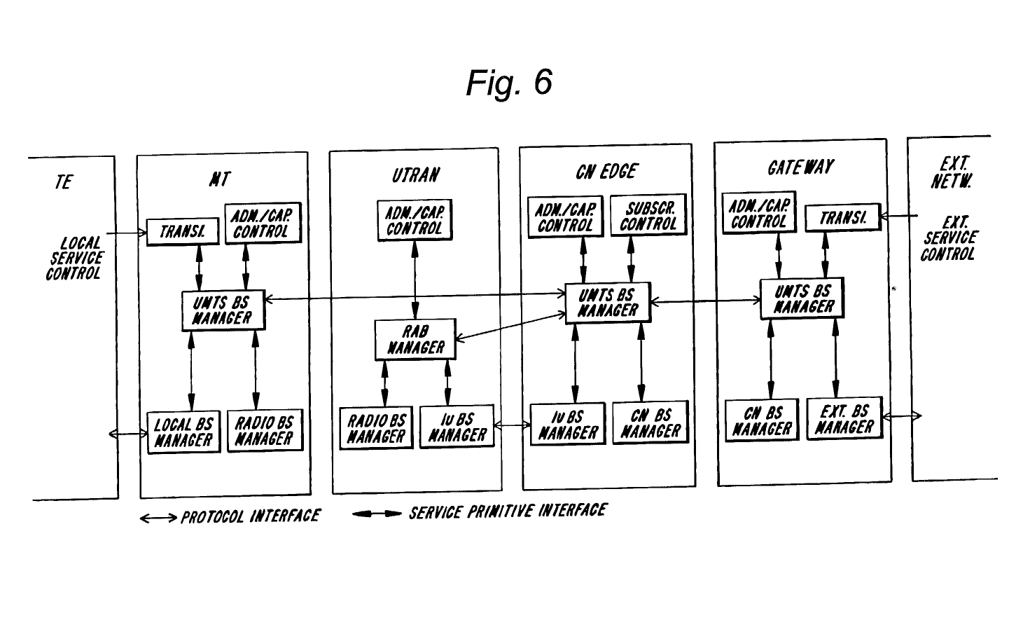

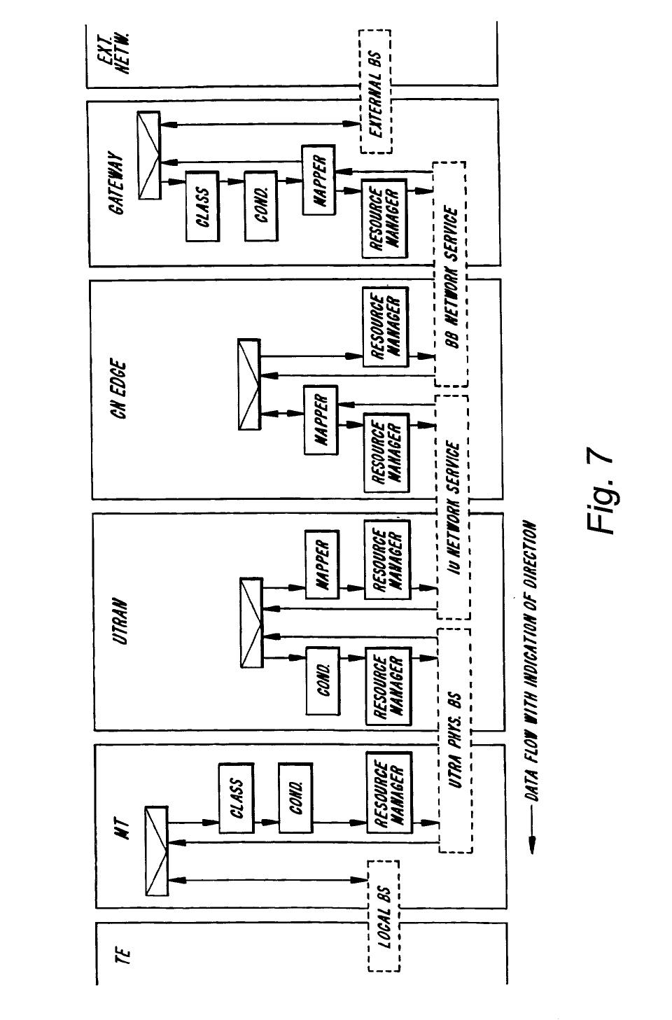

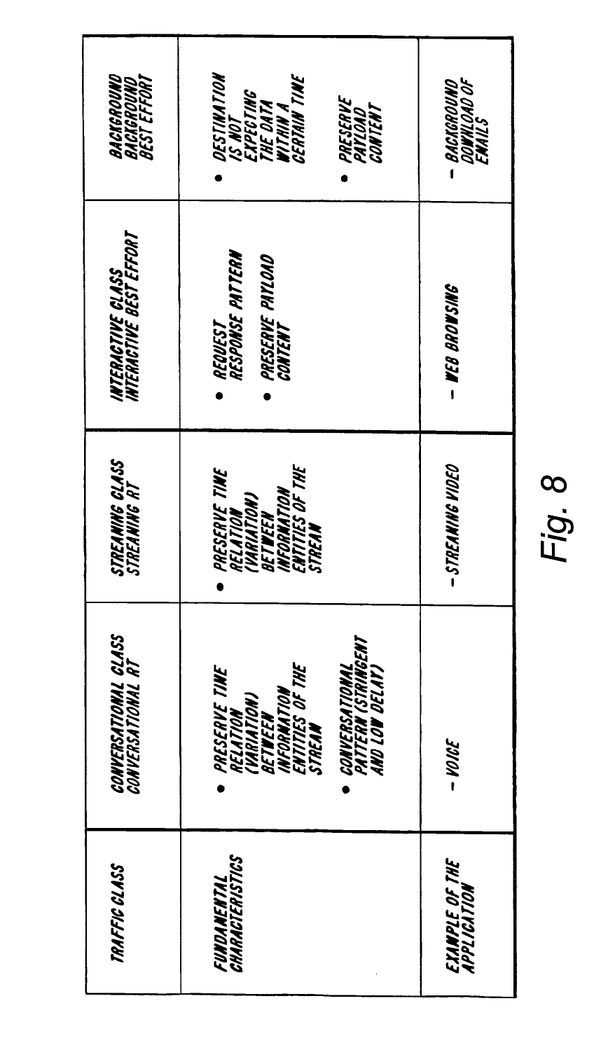

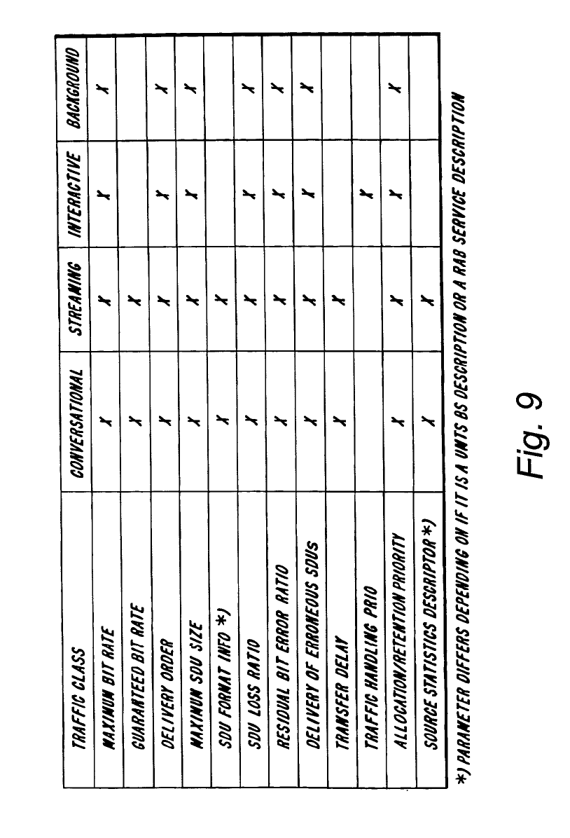

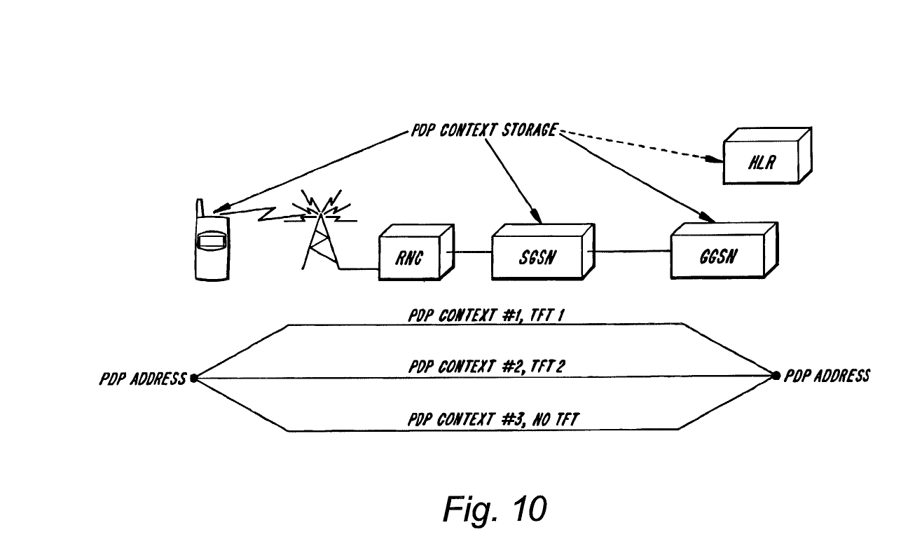

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details. For example, while one of the example embodiments is described in an example application where the local access networks are GPRS/UMTS networks, the present invention may be employed in any access network.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

In the following description, a mobile terminal is used as one example of a user equipment (UE) allowing a user access to network services. In a mobile radio communications system, the interface between the user equipment and the network is the radio interface. Thus, although the present invention is described using the term “mobile terminal,” the present invention may be applied to any type or configuration of user equipment that can communicate over a radio interface.

As explained above, to provide IP quality of service end-to-end from mobile terminal to a remote host, it is necessary to manage the quality of service within each domain in the end-to-end path where each domain corresponds to a set of nodes utilizing the same QoS mechanisms. An IP bearer service manager may be used to control the external IP bearer service through the IP packet data network, e.g., the Internet. However, there must be a way to interwork resources owned or controlled by the local access networks and resources in the IP packet data network to which the local access networks are coupled. This is particularly important for multimedia-type communications between two hosts.

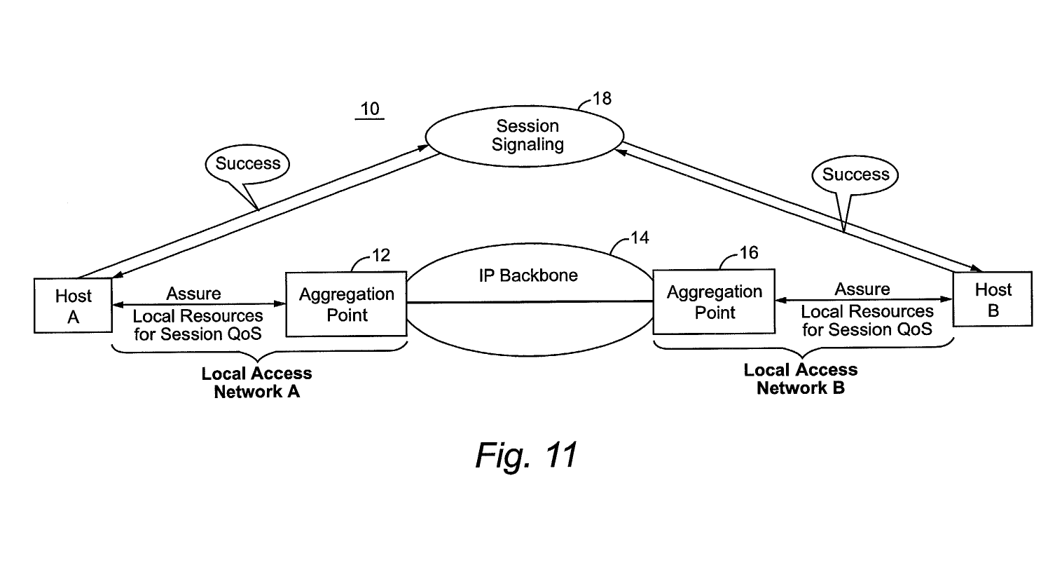

FIG. 11 illustrates an example communications system 10 in which a host A initiates a communications session with host B that includes two or more media data streams. Each media data stream in the session is requested by host A to have an particular quality of service, e.g., bit rate, delay time, etc. The session is initiated using a session signaling protocol 18. Both hosts are notified of the desired session, the media data streams to be supported for the session, and their respective quality of service parameters. Each host determines for its own local access network, up to the IP backbone coupling the local access networks A and B, whether there are sufficient resources to assure that the requested quality of service can be provided for each bearer supporting one of the media data streams. When host A determines that the quality of service can be delivered, either by explicit reservation or because there are sufficient resources available, it sends a “success” or other session signaling message to the host B. That message confirms that the local access network A can provide the necessary quality of service for the media data streams of the initiated session. Host B sends a similar “success” message to host A using the session signaling if its local access network B can provide the requested quality of service for each of the media data streams in the initiated session. Hosts A and B may make this quality of service determination during, for example, a packet data context activation procedure when the host requests a packet bearer to access its local access network.

If both local access networks are able to provide the requested quality of service, aggregation points 12 and 16 at the edge of each local access network A and B, respectively, ensure that the necessary quality of service is provided across the IP backbone 14. For example, Differentiated Services (DiffServ) edge functions may be employed in the aggregation points. In the routers of the IP network 14, different traffic priorities and different handling in the IP network are provided depending on the priority/QoS of a given data stream. The packets in the media data streams each have some sort of IP header that defines the QoS for the packet. For example, an IP version 4 header includes the type of service (TOS) field, and an IP version 6 header traffic class field. DiffServ renames these fields the DS field and encodes a DS Code Point (DSCP) with a corresponding quality of service code in each IP packet. Within the IP network 14, the values of the DSCP in a given IP packet are used to handle the packet according to certain per hop behavior (PHB). Therefore, all that is required within the core of the IP backbone network 14 is for the core routers to examine the DSCP of each packet and act accordingly. As explained above, edge routers corresponding to the aggregation points 14 and 16 in the local access networks A and B ensure that only qualified packets are marked with a particular DSCP value. To dimension the IP network in a cost effective way, each node that uses the IP network, e.g., the GGSN, will only be allowed to use a certain bandwidth for the traffic marked with a certain DSCP. If this limit is exceeded, the node (e.g., GGSN) rejects requests from the users (UE-A or UE-B). If the dimensioning is followed, the IP network will provide the necessary QoS for each media stream.

In this way, end-to-end quality of service for a multimedia session is assured without resorting to an explicit resource reservation protocol exchange such as RSVP. There is no need for RSVP-enabled routers to examine IP headers in any detail, and routers do not have to maintain the states for all existing reservations. Overhead is reduced. Flexibility and scalability are achieved with Differentiated Services (DiffServ). Although DiffServ is the preferred QoS provisioning mechanism in the IP network 14, other mechanisms are possible, such as asynchronous transfer mode (ATM). In addition, DiffServ is preferably supported by multi-protocol label switching (MPLS).

There may be a situation where one of the hosts A or B determines that its local access network is unable to provide or otherwise assure sufficient local resources for a quality of service requirement for the session. In that case, the initiating host (or either host) may decide to abort the session. On the other hand, the initiating host may decide to complete the session by changing some condition for the session. One example condition change is to change a quality of service criteria for one or more of the media data streams, e.g., to reduce or relax a quality of service requirement. Alternatively, another condition change might be to attempt to establish the session, without requiring any special QoS assurance for one or more media streams, allowing each side to use whatever QoS level that is provided by the local access network for that media stream, e.g., best effort.

Although it is unnecessary to employ a comprehensive reservation protocol like RSVP when another QoS protocol is used, such as a GPRS/UMTS reservation protocol, one of the hosts may nonetheless elect to use a second resource establishment method such as RSVP. Such an election typically depends on user preferences or the needs of a particular software application running at the local host. If RSVP has been elected but session setup with the requested QoS fails, the host may change the conditions for the session, as described above, and no longer use RSVP for bearer control.

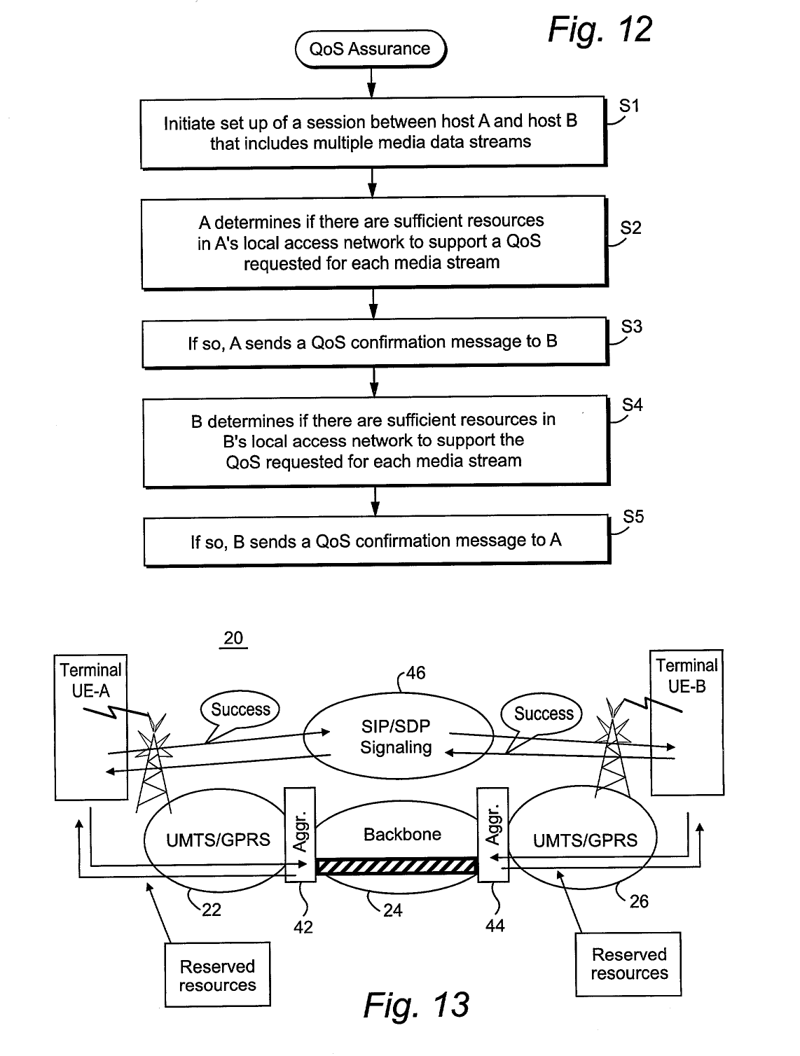

FIG. 12 illustrates in flowchart form one non-limiting example set of procedures for assuring quality of service for a multimedia session. Setup of a multimedia session with multiple media data streams is initiated between host A and host B using session setup signaling (step S1). Host A determines if there are sufficient resources in A's local access network to support a quality of service requested for each media data stream (step S2). If so, A sends a quality of service confirmation message to host B, preferably using the session setup signaling (step S3). Similarly, host B determines if there are sufficient resources in host B's local access network to support the quality of service requested for each media data stream (step S4). If so, host B sends a quality of service confirmation message to host A using, for example, the session signaling protocol (step S5).

As described above, if either confirmation message is not received or sent with a QoS failure indication, the host assumes that quality of service assurance cannot be fully met for the session. Consequently, the host may elect to abort the session setup or change some condition and make another attempt to setup the session. Although this kind of QoS assurance communication may occur as a part of every session set up, it may also be used selectively. In other words, host A may initially signal host B to determine if host B is capable of indicating QoS confirmation or QoS failure to host A. If host B's response is negative, then host A may elect to establish the session without requiring QoS assurance as mandatory, allowing host B to use whatever QoS level that is provided by the local access network, e.g., best effort, without confirming the result to host A.

Another non-limiting, example embodiment is described in conjunction with the communications system 20 shown in FIG. 13. A mobile terminal UE-A desires to set up a multimedia session with a mobile terminal UE-B. UE-A is serviced by a local access network over a radio interface. In this example, that local access network is a GPRS and/or UMTS access network 22 which is coupled to an IP backbone network 24 through an aggregation point 42. Similarly, UE-B coupled over a radio interface to the IP backbone network 24 through the GPRS and/or UMTS local access network and an aggregation point 44. The backbone network supports a quality of service provisioning mechanism such as Differentiated Services (DiffServ) as explained above.

The session setup is initiated using the well-known session initiation protocol (SIP)/session description protocol (SDP). In general, SIP is a signaling protocol that handles the setup, modification, and tear down of multimedia sessions. SIP, in combination with other protocols, describes the session characteristics to potential session participants. Even though SIP messages pass through some of the same physical facilities as the media to be exchanged, SIP signaling is considered separate from the media itself as illustrated in FIG. 13. Although SIP is the preferred signaling protocol, other protocols that can achieve these functions may also be used. SDP provides a format for describing session information to potential session participants. Session-level and media-level parameters are specified using certain SDP fields followed by SDP values.

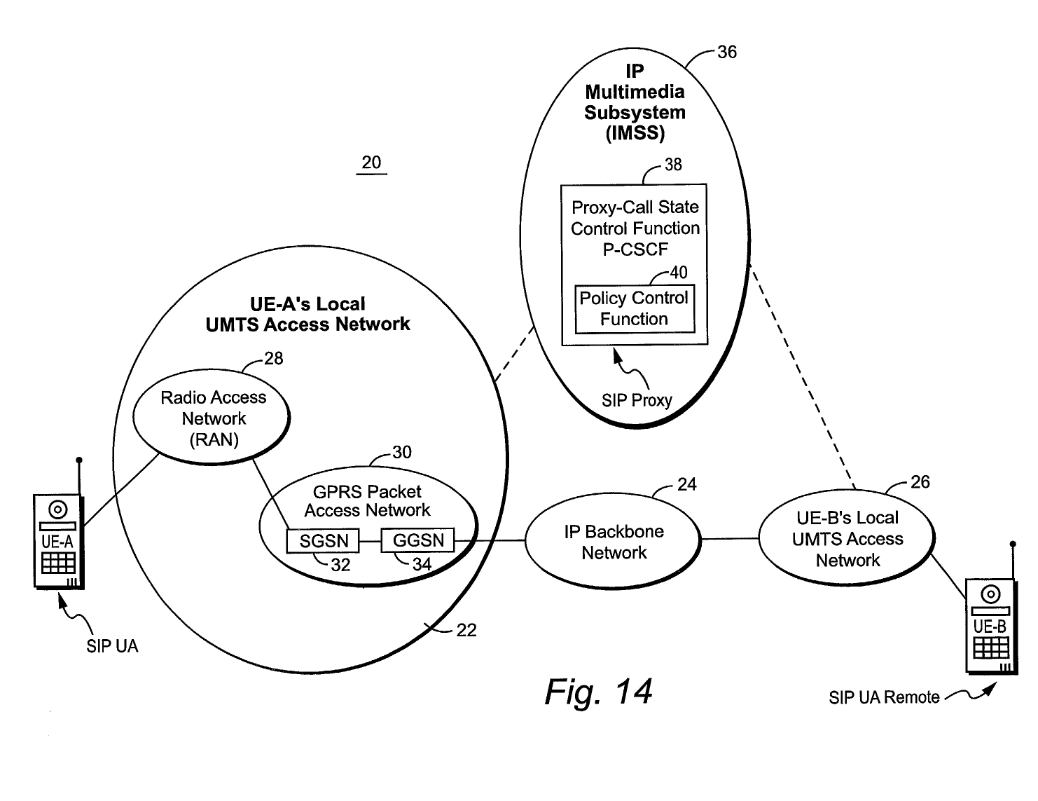

The communications system 20 is shown in further detail in FIG. 14. The mobile terminal UE-A, functioning as a SIP user agent (UA), communicates over a radio interface with a radio access network (RAN) 28 which is coupled to a GPRS packet network 30 in UE-A's local UMTS access network 22. The GPRS packet access network includes one or more serving GPRS support nodes (SGSN) 32 coupled to one or more gateway GPRS support nodes (GGSN) 34. The GGSN 34 performs a number of network edge functions including packet filtering and aggregation functions as well as interworking functions with the IP backbone network 24. Mobile terminal UE-B, referred to as the SIP user agent remote in FIG. 14, is coupled to the IP backbone 24 through its own local UMTS access network 26, which may also include its own RAN and GPRS packet access network (not shown).

Each GPRS packet network is coupled to an IP multimedia subsystem (IMSS) 36. Communication with the IMSS 36 (shown as dashed lines) permits exchange of multimedia session control related messages. The session is established and managed using SIP/SDP. The IMSS 36 includes a call state control function (CSCF), in this example, a proxy-CSCF (P-CSCF) 38 is shown and a policy control function (PCF) 40. The P-CSCF 38 and PCF 40 may be implemented on the same or different servers. The P-CSCF 38 functions as a SIP proxy for the SIP user agents. The IMSS 36 is typically part of (although it may be separate from and coupled to) the IP backbone network 24. In the example where the mobile terminal UE-A desires to establish a multimedia session with UE-B, the packet traffic for this session follows the solid line couplings between the various nodes.

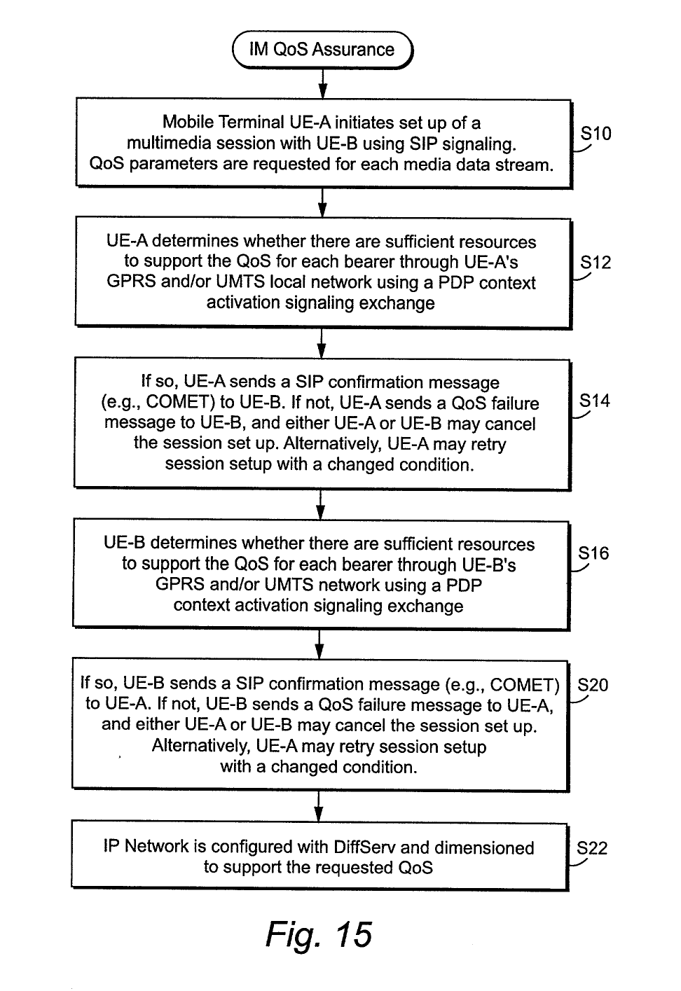

Example, non-limiting procedures for assuring quality of service for the example IP multimedia session in communications system 20 are now described in the flowchart of FIG. 15 entitled IM QoS assurance. The mobile terminal UE-A initiates setup of a multimedia session with UE-B using SIP/SDP signaling. As part of session setup, quality of service parameters are requested for each media data stream in the session (step S10). At the request of UE-B, UE-A determines whether there are sufficient resources to support the quality of service for each bearer to be allocated for each media data stream through UE-A's GPRS and/or UMTS local network using a PDP context activation signaling exchange (step S12). If so, UE-A sends a SIP confirmation message, (e.g., a “condition met” COMET SIP message), to UE-B. If not, UE-A sends a QoS failure message to UE-B, and either UE-A or UE-B may cancel the session setup. Instead of cancellation, UE-A may retry to setup the session with one or more changed conditions (step S14).

At the request of UE-A, UE-B determines whether there are sufficient resources to support the quality of service for each required session bearer through UE-B's GPRS and/or UMTS network using the PDP context activation signaling exchange (step S16). If so, UE-B sends a SIP confirmation message, (e.g., a COMET message) to UE-A. If not, UE-B sends a QoS failure message to UE-A, and either UE-A or UE-B may cancel the session setup. Instead of cancellation, UE-A may retry setting up the session with one or more changed conditions (step S20). The IP backbone network is configured with DiffServ and dimensioned to support the requested quality of service for each media data stream (step S22).

As a part of the PDP context establishment procedure for each session bearer in each local access network, an admission controller in the GGSN in that local access network checks to ensure there are sufficient resources available to support the corresponding media data flow in the local access network. More specifically, each GGSN is allocated a particular amount of bandwidth. The GGSN adds and subtracts the allocated bandwidth when PDP contexts are established or removed, respectively. Of course, if the allocated bandwidth exceeds the preconfigured amount, further PDP context requests are rejected. In the IP backbone network, all routers are configured with a bandwidth is equal to or greater than the sum of all the preassigned bandwidths from the GGSNs. This router bandwidth configuration is implemented by agreements between various network providers/operators. Accordingly, when a PDP context is activated, there will be sufficient resources to provide the necessary quality of service in the IP backbone which is implemented in the IP backbone using, for example, DiffServ.

Accordingly, each UE mobile terminal assumes that the other UE mobile terminal in the session is responsible for and will reserve resources or assure sufficient resources for uplink and downlink quality of service flows in the session. When quality of service assurance procedures are in effect, each UE mobile terminal informs the other UE with SIP messages if it has sufficient resources in its local network. Specifically, the UE communicates whether there are sufficient resources to support the uplink and downlink quality of service for each media data stream from the UE terminal through its local UMTS/GPRS network up to the GGSN aggregation point. Quality of service is assured through admission control administered at the aggregation point/GGSN per PDP context, and therefore, also per media flow. Once admitted into the IP network, the flows are aggregated into different classes (e.g. DiffServ classes). The quality of service is assured at each IP backbone router by controlling the aggregated traffic in accordance with DiffServ procedures.

Thus, each UE, irrespective of which UE initiates the session, is responsible for ensuring that a satisfactory quality of service/PDP context is established for each media data stream in the session through its local access network in each direction, (i.e., uplink and downlink). The quality of service conditions for a particular media data stream in a certain direction are met when a satisfactory PDP context is established at the local access network for that media data stream bearer for that direction. This, coupled with DiffServ provisioned QoS in the IP backbone, assures end-to-end quality of service is assured for a multimedia session without suffering the drawbacks of a formal resource reservation procedure like RSVP. For end-to-end QoS to be assured, the IP backbone must be correctly dimensioned and an admission control function in GGSN must ensure that the IP backbone is not overloaded.

On the other hand, there may be situations where additional optional actions/conditions may be desirable. For example, the UE may optionally employ a second resource establishment/reservation method such as RSVP to support RSVP-based APIs and applications. Action must be taken if the UE is unable to fulfill the quality of service for one or more of the media data streams in the session. If the reason for QoS failure is a lack of resources in any network, the UE may abort the session. On the other hand, the UE may relax one of the quality of service conditions for one or more of the bearers and reinitiate session setup. Still further, if RSVP was selected to support an application or API, the reason for failure may be lack of support for RSVP in the network or remote host rather than a lack of resources. In this case, the present invention may be used to setup a QoS assured multimedia session without using RSVP.

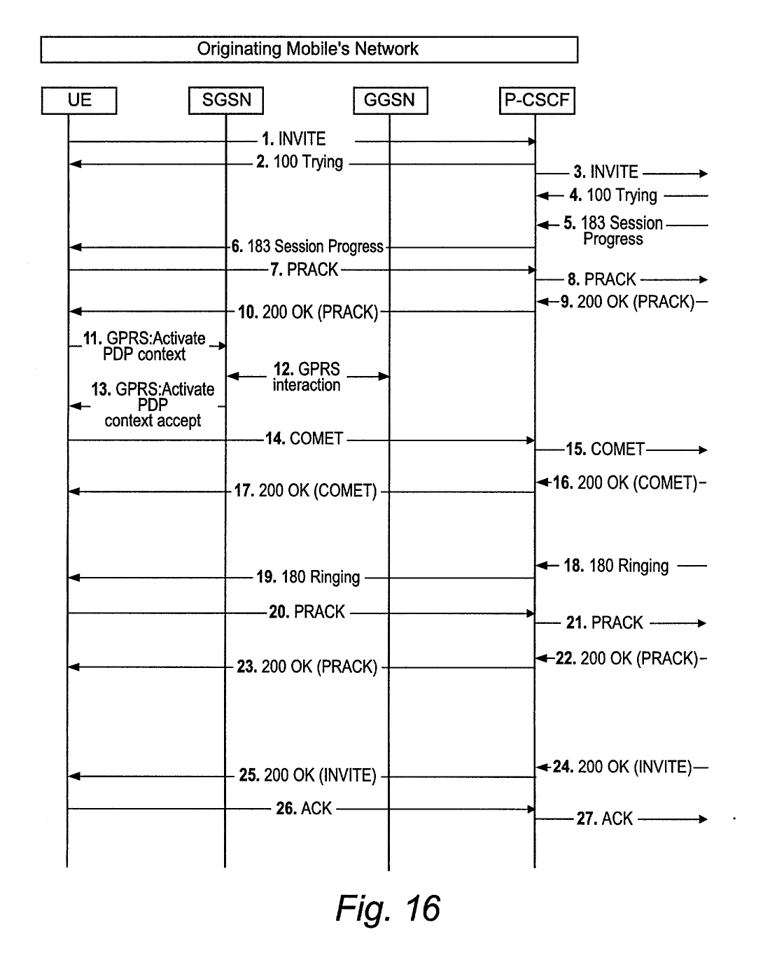

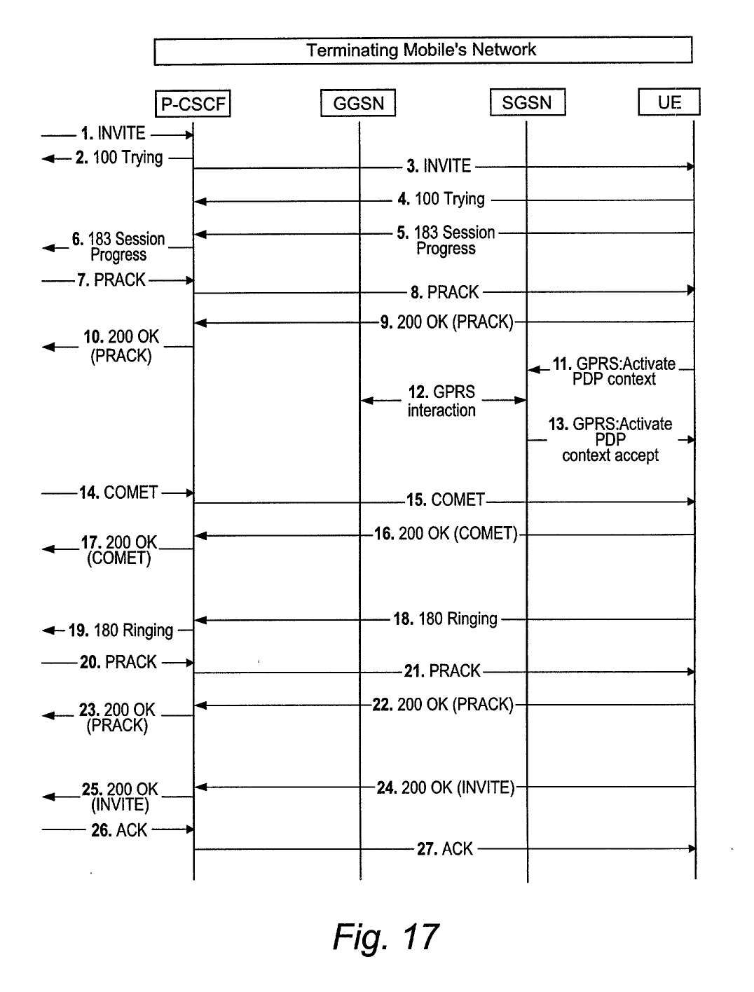

Two example signaling diagrams for establishing a multimedia session and assuring quality of service are illustrated in FIGS. 16 and 17. FIG. 16 illustrates signaling where a session is originated at the UE, and FIG. 17 illustrates session signaling for the terminating UE. Because the messages are quite similar, the descriptions of the messages illustrated in FIG. 16 are applicable to the messages shown in FIG. 17.

The INVITE request message (1) initiates a multimedia session and includes information specifying the calling and called parties, the type of media to be exchanged, and quality of service information. More specifically, the INVITE request (1) contains an initial SDP to the P-CSCF 38 in the IMSS 36 which contains, in addition to other mandatory and optional fields/values describing the session, the set of codecs supported by the initiating UE. In addition, it includes the SDP attribute entry “a=qos: mandatory sendrecv” which means that QoS assurance will be supported in both the send and receive directions for the media in question, i.e., the QoS precondition is mandatory. UE-A does not request UE-B to send a special COMET message (no “confirm tag”) when the resources are assured. Instead, the confirmation of the resources will be “piggy-backed” on the last 200 OK (INVITE) message (24). Message (2), “100 Trying,” is simply an informational message indicating that the INVITE request is received by the P-CFCF and that the requested session characteristics are being processed. The INVITE message is forwarded at (3) by the P-CSCF to UE-B via the IP backbone network and UE-B's local access network. Message (4) is another “trying” message indicating that UE-B is working on the INVITE request.

The fifth message (5) is a SIP 183 session progress response message which informs UE-A of the capabilities of UE-B, e.g., assurance of the requested QoS. Specifically, message (5) describes the set of codecs supported by UE-B for the session and includes the entry “a=qos:mandatory sendrecv confirm.” This message informs UE-A that UE-B is capable of supporting the required message exchange to confirm the assurance of QoS resources in both the send and receive directions for the media in question. UE-B furthermore requests (with the “confirm tag”) from UE-A that a special COMET message be sent when the resources at UE-A side are assured. That is, UE-A is requested to send a confirmation message (COMET) to UE-B when the resources of its local access network are reserved for the session.

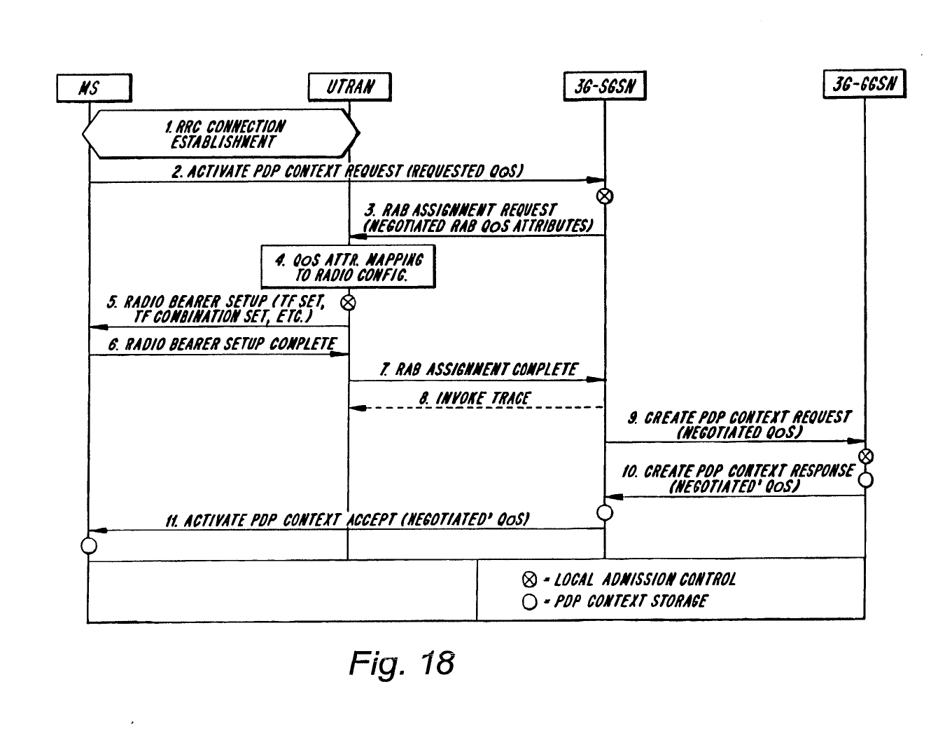

This SIP 183 message (5) is forwarded as message (6) from the P-CSCF to UE-A. A provisional acknowledgment (PRAC) is forwarded to the P-CSCF from the UE-A in message (7) and from the P-CSCF to the UE-B in message (8). A SUCCESS message “OK” with respect to the provisional acknowledgment is returned via messages (9) and (10) to UE-A. The UE-A, in message (11), sends a GPRS activate PDP context message to the SGSN in its local access network requesting a UMTS/GPRS bearer with a QoS corresponding to the QoS requirements for the media streams. The PDP context is bi-directional. In message (12), GPRS interaction procedures are followed to create the PDP context. These procedures are described now in conjunction with FIG. 18.

The PDP context signaling carries the requested and negotiated QoS profile between the nodes in the UMTS network. It has a central role for QoS handling in terms of admission control, negotiation, and modifying of bearers on a QoS level. The PDP context signaling message exchanges are described below with reference to the numerals in FIG. 18.

1. A radio resource control (RRC) connection establishment is performed. This procedure is needed for establishing a connection, but does not cover more from a QoS perspective than that the type of radio channel is roughly indicated.

2. The MS sends a PDP message, “Activate PDP context request,” to the SGSN. The requested QoS profile is included in this message. At this stage, the SGSN makes an admission check and might restrict the requested QoS if the system is overloaded.

3. The SGSN sends an RANAP message, “RAB Assignment Request,” to the RNC in the UTRAN. RANAP, or Radio Access Network Application Part, is an application protocol for supporting signaling and control transmission between the UTRAN and the external CN. RANAP permits communication between the UTRAN and circuit-switched or packet-switched networks. This request to establish a radio access bearer (RAB) service carries the (perhaps modified) RAB QoS attributes.

4. From the RAB QoS attributes, the RNC determines the radio-related parameters corresponding to the QoS profile, e.g., transport format set, transport format combination set, etc. In addition, the UTRAN performs an admission control on this bearer.

5. The RNC sends an RRC message, “Radio Bearer Set-up,” to the MS. The RRC message includes the radio-related parameters that were determined in step 4.

6. The UTRAN and the MS apply the radio parameters and are ready to transfer traffic. To signal this, the MS sends a “Radio Bearer Set-up Complete” RRC message to the RNC.

7. The UTRAN sends a “RAB Assignment Complete” RANAP message to the SGSN.

8. A Trace procedure may be initiated. This is an operation and maintenance function for surveying subscribers.

9. The SGSN sends a “Create PDP Context Request” to the GGSN carrying the QoS profile. However, the QoS profile may have different parameters than those requested by the MS in step 2. Based on this profile, an admission control is performed at the GGSN level, and the GGSN may restrict the QoS if, for example, the system is overloaded. The GGSN stores the PDP context in its databases.

10. The GGSN returns the negotiated QoS to the SGSN in a “Create PDP Context Response” message and the SGSN stores the PDP context in its database.

11. The negotiated QoS is sent from the SGSN to the MS in an “Activate PDP Context Accept” message. If either the SGSN or the GGSN has modified the QoS profile, then the MS has to either accept or reject this profile.

Returning to FIG. 16, the SGSN sends an activate PDP context accept message (13) to UE-A indicating that the necessary resources to support this media data stream of the session can be assured. A condition met (COMET) confirmation message (14) is sent from UE-A to the P-CSCF when the UE-A finishes the quality of service assurance (or reservation) for both the uplink and downlink directions for each media data stream according to the PDP activate context procedures described above. The COMET message is sent via the same path of the INVITE request as indicated in message (15). The COMET message includes in its SDP information indicating a successful quality of service bi-directional assured mode due to the successful bi-directional PDP context established for each one of the media data streams in the session. Specifically, the SDP includes the entry “a=qos: success sendrecv.” UE-B responds via the CSCF with a 200 OK response to the COMET request in messages (16) and (19).

Upon reception of the COMET message, UE-B may alert the end user (e.g., generate a ringing sound) and inform UE-A that the terminal of UE-B is ringing by sending a 180 ringing signal to UE-A via the P-CSCF in messages (18) and (19). PRACK messages (20) and (21) acknowledge the 180 ringing response. A 200 OK message (22) is provided by UE-B via P-CSCF to UE-A. Messages (24) and (25) are the call through message and response to the original INVITE message (#1 and #3). Here, UE-B also informs UE-A of the results of the quality of service procedures performed in UE-B's local access network. If there is a successful completion, and the QoS is assured, the 200 OK (INVITE) message will contain the entry “a=qos: success sendrecv.”

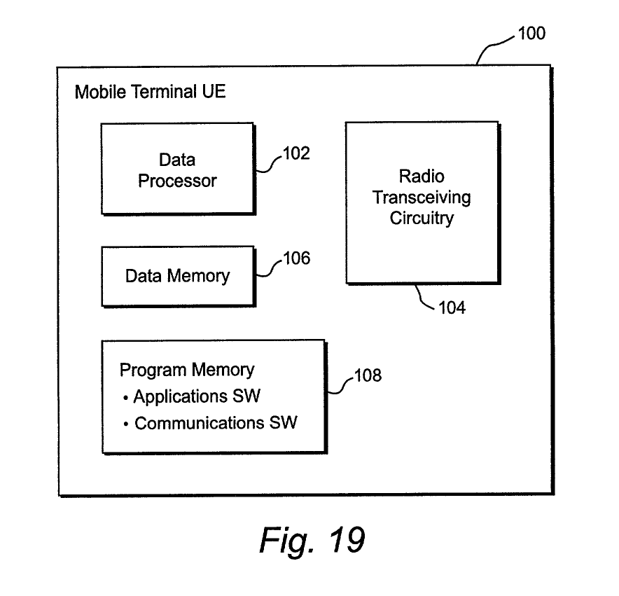

Much of the signaling and functions described above are performed in the mobile terminal UE. Accordingly, FIG. 19 illustrates in simplified function block format an example mobile terminal UE 100. Mobile terminal UE 100 includes a data processor 102, radio transceiving circuitry 104, a data memory 106, a program memory 108 which includes, for example, application software and communications software. The applications and communications software in the program memory 108 is executed by the data processor to process received signaling messages as well as the media data stream data and formulate appropriate SIP messages as described above. It is to be understood that other nodes shown in the various figures above are configured with appropriate hardware and software to perform their respective tasks described above.

The present invention assures end-to-end quality of service for a multimedia session without the considerable overhead associated with resource reservation protocols such as RSVP. This is particularly important over the radio interface where bandwidth is a scarce resource. Session setup is completed more quickly because end-to-end message exchanges are avoided. Still further, increased flexibility and scalability are achieved because the differentiated services protocol is a particularly scalable protocol. Added complexity is avoided in UE terminals and GGSN nodes since they do not need to include RSVP software in addition to the existing PDP context software that is necessary to control quality of services at the bearer level in UMTS networks.

The invention is particularly advantageous for conversational multimedia sessions between two mobile terminals. In this case, a host accesses the services over a limited bandwidth radio link both on the local side and on the remote side. A multimedia application may suffer bad performance not only because the local access network of the local host has insufficient resources, but also because the local access of the remote host has insufficient resources. If each user pays for the volume of data transmitted by the local access network of the user, it is important for each user to know that the multimedia application will perform in a predictable and acceptable manner before establishing the session. The invention also allows a multimedia application to alert the remote host user of the multimedia session only when all required resources are established and available. This allows, for example, voice-over-IP applications to work according to the well known behavior of PSTN voice telephony.

While the present invention has been described with respect to particular embodiments, those skilled in the art will recognize that the present invention is not limited to these specific exemplary embodiments. Different formats, embodiments, and adaptations besides those shown and described as well as many variations, modifications, and equivalent arrangements may also be used to implement the invention. Therefore, while the present invention has been described in relation to its preferred embodiments, it is to be understood that this disclosure is only illustrative and exemplary of the present invention. Accordingly, it is intended that the invention be limited only by the scope of the claims appended hereto.

What is claimed is:

1. A method for assuring a quality of service for a multimedia session including plural media data streams between a first user terminal associated with a first local access network and a second user terminal associated with a second local access network, where the first and second local networks are coupled to an IP network, comprising:
the first user terminal determining whether there are sufficient resources in the first local access network to support a quality of service requested for each of the media data streams; and furthermore that the media data streams are allowed to use the IP network via the first local access network and
the first user terminal sending a first message to the second user terminal confirming that determination;
the second user terminal determining whether there are sufficient resources in the second local access network to support a quality of service requested for each of the media data streams; and
the second user terminal sending a second message to the first user terminal confirming that determination,
wherein the sending of the first and second messages assures the requested quality of service for each media data stream in the session will be provided.

2. The method in claim 1, wherein the IP network supports the requested quality of service for each media data stream in the session, and wherein the first user terminal determines whether the media data streams can use the IP network via the first local access network and the second user terminal determines whether the media data streams can use the IP network via the second local access network.

3. The method in claim 2, wherein a differentiated services provisioning mechanism is used to deliver the requested quality of service for each media data stream in the session across the IP network.

4. The method in claim 1, wherein requested quality of service for each media data stream in the session is assured without using a resource-reservation protocol (RSVP).

5. The method in claim 1, wherein if the requested quality of service for each media data stream in the session can not be provisioned in one of the first and second local access networks, the session is not set up.

6. The method in claim 1, wherein if the requested quality of service for each media data stream in the session can not be provisioned in one of the first and second local access networks, a setup of the session is attempted with a changed quality of service condition for one or more of the media data streams in the session.

7. The method in claim 1, wherein the first user terminal determines whether there are sufficient resources in the first local access network to support a quality of service requested for each of the media data streams in a first direction from the first terminal to the second terminal and in a second direction from the second terminal to the first terminal, and
wherein the second user determines whether there are sufficient resources in the second local access network to support a quality of service requested for each of the media data streams in a first direction from the first terminal to the second terminal and in a second direction from the second terminal to the first terminal.

8. The method in claim 1, further comprising:
the second user terminal informing the first user terminal that the second user terminal lacks capabilities to send the second message for one or more of the media streams, and
the first user terminal informing the second user terminal that the first user terminal will proceed with the multimedia session without the second terminal sending the second message.

9. The method in claim 1, wherein the first and second messages are communicated using session initiation protocol (SIP) signaling.

10. The method in claim 1, wherein the first and second local access networks are mobile radio access networks and the first and second user terminals are mobile terminals, and
wherein the first and second mobile terminals determine whether there are sufficient resources in the first and second mobile radio access networks, respectively, to support a quality of service requested for each of the media data streams using a mobile radio access network quality of service reservation procedure at a radio access bearer level for each of the media data streams.

11. The method in claim 10, wherein the first and second mobile radio access networks are GPRS or UMTS networks, and
wherein the first and second mobile terminals determine whether there are sufficient resources in the first and second GPRS or UMTS networks, respectively, to support a quality of service requested for each of the media data streams using a PDP context signaling procedure.

12. A method for end-to-end resource coordination for a multimedia session including plural media data streams between a first mobile terminal associated with a first local access network and a second mobile terminal associated with a second local access network, where the first and second local networks are coupled to an IP network, comprising:
the first mobile terminal using a PDP context activation procedure to determine if sufficient resources can be provisioned in the first local access network to support a quality of service (QoS) requested for each of the media data streams in the session, and if so, sending a first QoS confirmation message to the second mobile terminal, and
the second mobile terminal using a PDP context activation procedure to determine if sufficient resources can be provisioned in the second local access network to support a quality of service (QoS) requested for each of the media data streams in the session, and if so, sending a second QoS confirmation message to the first mobile terminal.

13. The method in claim 12, wherein the first and second QoS confirmation messages confirm end-to-end provision of the requested quality of service for each media data stream in the session.

14. The method in claim 12, wherein the first and second mobile terminals provision sufficient resources to support a quality of service requested for each direction of each of the media streams.

15. The method in claim 12, further comprising:
the second mobile terminal informing the first mobile terminal that the second mobile terminal lacks capabilities to send the second message for one or more of the media streams, and
the first mobile terminal informing the second mobile terminal that the first mobile terminal will proceed with the multimedia session without the second mobile terminal sending the second message.

16. The method in claim 12, wherein the first and second local access networks are GPRS or UMTS networks.

17. The method in claim 12, wherein the IP network supports the requested quality of service for each media data stream in the session.

18. The method in claim 17, wherein a differentiated services provisioning mechanism is used to deliver the requested quality of service for each media data stream in the session across the IP network.

19. The method in claim 12, wherein requested quality of service for each media data stream in the session is assured without using a resource-reservation protocol (RSVP).

20. The method in claim 12, wherein if the requested quality of service for each media data stream in the session can not be provisioned in one of the first and second local access networks, the session is not set up.

21. The method in claim 12, wherein if the requested quality of service for each media data stream in the session can not be provisioned in one of the first and second local access networks, setup of the session is attempted with a changed condition.

22. The method in claim 21, wherein the changed condition may be applied to one or more media streams in the second local access network.

23. The method in claim 21, wherein the changed condition is a reduced quality of service for one or more of the media data streams.

24. The method in claim 12, wherein the first and second messages are communicated using session initiation protocol (SIP) signaling.

25. The method in claim 12, wherein if the requested quality of service for each media data stream in the session can not be provisioned in one of the first and second local access networks, the first mobile terminal informs the second mobile terminal that the second mobile terminal need not determine if sufficient resources can be provisioned in the second local access network, and the first and second mobile terminal complete the multimedia session setup without using QoS confirmation messages for the one or more media streams.

26. The method in claim 12, wherein if the requested quality of service for each media data stream in the session can not be provisioned in one of the first and second local access networks, the first mobile terminal does not determine if sufficient resources can be provisioned in the first local access network and informs the second mobile terminal that the second mobile terminal not to determine if sufficient resources can be provisioned in the second local access network.

27. The method in claim 12, wherein if the requested quality of service for each media data stream in the session can not be provisioned in one of the first and second local access networks, the first and second mobile terminal complete the multimedia session setup without using QoS confirmation messages for the one or more media streams.

28. A first mobile radio terminal for determining a quality of service for a multimedia session including plural media data streams between the first mobile radio terminal associated with a first local mobile access network and a second user terminal associated with a second local access network, where the first local mobile access network and the second local network are coupled to an IP network, comprising:
radio transceiving circuitry, and
electronic circuitry, coupled to the radio transceiving circuitry, configured to determine whether there are sufficient resources in the first local mobile access network to support a quality of service requested for each of the media data streams and to send a confirmation message to the second user terminal confirming that determination.

29. The first mobile radio terminal in claim 28, wherein the electronic circuitry is configured to detect a confirmation message from the second user terminal indicating that there are sufficient resources in the second local access network.

30. The first mobile radio terminal in claim 29, wherein the confirmation message detected from the second user terminal indicates that the media data streams are allowed to use the IP network via the second local mobile access network to support a quality of service requested for each of the media data streams.

31. The first mobile radio terminal in claim 28, wherein the confirmation message from the first user terminal indicates that the media data streams are allowed to use the IP network via the first local mobile access network to support a quality of service requested for each of the media data streams.

32. The first mobile radio terminal in claim 28, wherein a differentiated services provisioning mechanism is used to deliver the requested quality of service for each media data stream in the session across the IP network.

33. The first mobile radio terminal in claim 28, wherein requested quality of service for each media data stream in the session is assured without using a resource-reservation protocol (RSVP).

34. The first mobile radio terminal in claim 28, wherein if the requested quality of service for each media data stream in the session can not be provisioned in one of the first and second local access networks, the electronic circuitry is configured to abort setup of the session.

35. The first mobile radio terminal in claim 28, wherein if the requested quality of service for each media data stream in the session can not be provisioned in one of the first and second local access networks, the electronic circuitry is configured to attempt to setup the session with a changed quality of service condition for one or more of the media data streams in the session.

36. The first mobile radio terminal in claim 28, wherein the electronic circuitry is configured to assure there are sufficient resources in the first local access network to support a quality of service requested for each of the media data streams in a first direction from the first terminal to the second terminal and in a second direction from the second terminal to the first terminal.

37. The first mobile radio terminal in claim 28, wherein the electronic circuitry is configured to detect a message from the second mobile terminal indicating that there are insufficient resources in the second local access network to support a quality of service requested for each of the media data streams.

38. The first mobile radio terminal in claim 37, wherein the electronic circuitry is configured to inform the second mobile terminal that setup of the multimedia session will proceed even though there are insufficient resources in the second local access network to support a quality of service requested for each of the media data streams.

39. The first mobile radio terminal in claim28, wherein the confirmation message is communicated using session initiation protocol (SIP) signaling.

40. The first mobile radio terminal in claim 28, wherein the first and second local access networks are mobile radio access networks and the second user terminal is a mobile terminal.

41. The first mobile radio terminal in claim 40, wherein the first and second mobile radio access networks are GPRS or UMTS networks, and
wherein the electronic circuitry is configured to assure there are sufficient resources in the first GPRS or UMTS network to support a quality of service requested for each of the media data streams using a PDP context signaling procedure.

42. A communications system providing resources for a multimedia session including plural media data streams between first and second mobile terminals, comprising:
an IP network;
a first local mobile access network coupled to the IP network;
a first mobile terminal associated with the first local mobile access network configured to use a procedure to establish a packet data connection from the first mobile terminal through the first local mobile access network and to determine if sufficient resources can be provisioned in the first local mobile access network to support a quality of service (QoS) requested for each of the media data streams in the session, and furthermore, that the media data streams are allowed to use the IP network via the first local access network, and if so, to send a first QoS confirmation message to the second mobile terminal;
a second local mobile access network coupled to the IP network; and
a second mobile terminal associated with the second local mobile access network configured to use a procedure to establish a packet data connection from the first mobile terminal through the first local mobile access network and to determine if sufficient resources can be provisioned in the second local mobile access network to support a quality of service (QoS) requested for each of the media data streams in the session, and furthermore, that the media data streams are allowed to use the IP network via the second local access network, and if so, to send a second QoS confirmation message to the first mobile terminal.

43. The communications system in claim 42, wherein a procedure to establish a packet data connection from the first mobile terminal through the first local mobile access network is a PDP context activation procedure.

44. The communications system in claim 42, wherein the first and second QoS confirmation messages confirm end-to-end provision of the requested quality of service for each media data stream in the session.

45. The communications system in claim 42, wherein the first and second mobile terminals determine if there are sufficient resources in their respective local mobile access networks to support a quality of service requested for each direction of each of the media streams.

46. The communications system in claim 42, wherein the second mobile terminal is configured to inform the first mobile terminal whether there are sufficient resources in the second local access network to support a quality of service requested for each of the media data streams, and
wherein if there are insufficient resources, the first mobile terminal is configured to inform the second mobile terminal that set up of the multimedia session will proceed without the second mobile terminal sending the second QoS confirmation message.

47. The communications system in claim 42, wherein the IP network supports the requested quality of service for each media data stream in the session.

48. The communications system in claim 47, wherein a differentiated services provisioning mechanism is used to deliver the requested quality of service for each media data stream in the session across the IP network.

49. The communications system in claim 42, wherein requested quality of service for each media data stream in the session is determined without using a resource-reservation protocol (RSVP).

50. The communications system in claim 42, wherein if the requested quality of service for each media data stream in the session can not be provisioned in one of the first and second local mobile access networks, one of the first and second mobile terminals is configured to abort set up of the session.

51. The communications system in claim 42, wherein if the requested quality of service for each media data stream in the session can not be provisioned in one of the first and second local access networks, one of the first and second mobile terminals is configured to attempt setup the session with a changed condition.

52. The communications system in claim 51, wherein the changed condition is a reduced quality of service for one or more of the media data streams.

53. The communications system in claim 51, wherein the changed condition is that the second mobile terminal is not required to determine if sufficient resources can be provisioned in the second local access network and the first and second mobile terminal complete set up of the multimedia session without using QoS confirmation messages for the one or more media streams.

54. The communications system in claim 51, wherein the changed condition is that the first mobile terminal does not determine if sufficient resources can be provisioned in the first local access network and informs the second mobile terminal that the second mobile terminal need not determine if sufficient resources can be provisioned in the second local access network for the session, the first and second mobile terminal completing setup of the multimedia session without using QoS confirmation messages for the one or more media data streams.

55. The communications system in claim 42, wherein the second mobile terminal informs the first mobile terminal that there are insufficient resources in the second local access network to support a quality of service requested for each of the media data streams, and in response, the first mobile terminal informs the second mobile terminal that the multimedia session will proceed without the second mobile terminal sending the second message for each of the media streams.

56. The communications system in claim 49, wherein the session setup, request, and first and second QoS confirmation messages are communicated using session initiation protocol (SIP) signaling.
